(19) United States
(12) Patent Application Publication
(10) Pub. No.: US 2012/0025515 A1
(43) Pub. Date: Feb. 2, 2012

(54) Assembly Comprising an Article to be Authenticated and an Authenticating Composition, and Related Methods

(75) Inventors: Sandrine Rancien, La Murette (FR); Celine Desnous, Voiron (FR)

(73) Assignee: ARJOWIGGINS SECURITY, Paris (FR)

(21) Appl. No.: 13/141,615

(22) PCT Filed: Dec. 23, 2009
(86) PCT No.: PCT/IB2009/055932

§ 371 Date: Oct. 12, 2011

(30) Foreign Application Priority Data
Dec. 23, 2008 (FR) 08 59016

(51) Int. Cl. B42D 15/00; B41M 3/14; B42D 15/10

(52) U.S. Cl. 283/81; 283/95; 283/74; 427/7

(57) ABSTRACT

The invention relates to an assembly including an article to be authenticated, an authentication composition and a member for applying the composition, capable of retaining said composition by capillarity, wherein the article to be identified contains a first reagent selected from nickel, copper, cobalt or iron derivatives, or from dithiooxamide or oxime derivatives capable of reacting with a second reagent of the authentication composition selected respectively from among dithioxmide or oxmime derivatives or from nickel, copper, cobalt or iron derivatives, so as to form a visible and permanent coloured mark.

The present invention relates to the field of articles to be authenticated, for example security documents. It relates to a combination comprising an article to be authenticated and an authenticating composition and to an associated authenticating method and an associated manufacturing process.

### BACKGROUND

In order to be protected against forgery or falsification of security documents and in order to increase the level of securing of these documents, it is known to incorporate therein security elements which make it possible to authenticate or identify the documents.

It is possible, for example, to incorporate, in or on the documents, authenticating security elements, such as particles, strands or tapes, fibers or small boards, which may be luminescent, having variable optical effects, such as iridescence, be magnetic or be conductive, in particular metallic. Use is also made of watermarks or pseudowatermarks to authenticate security documents.

In addition, there exist security papers which can be authenticated using specific authenticating compositions.

Patent application EP 0 391 542 describes a system for authenticating a security paper comprising a security paper comprising starch and an iodate salt, and an authenticating composition comprising an acid solution of an iodide. On application of the authenticating composition to the security paper, iodine is produced and a coloration characteristic of the starch/iodine combination is visible.

Patent DE 856 842 describes a paper comprising a pH indicator capable of becoming differently colored when the paper is moistened with water having a given pH. The paper exhibits the initial coloring of the pH indicator before brought into contact with the water.

Patent U.S. Pat. No. 6,783,991 also describes a paper comprising a pH indicator in the nonionic form which can react with an activating solution to give a colored mark which disappears when the activating solution dries.

Patent application EP 0 440 554 relates to an authenticatable document comprising an electron-accepting compound in the solid form (color developer) which can react with an authenticating composition comprising an electron-donating reactant (color former).

Patent application EP 0 090 130 describes a method for authenticating a certificate of value made of paper which consists in depositing, on the paper, one of the two substances of a colored reaction system comprising an electron-donating substance (color former) and an electron-accepting substance (color developer). The other of the two substances is placed in a dispenser which makes it possible to write or print on the paper where the first substance features. The principle of the colored reaction used in this patent application is well known in the field of carbonless copy paper and is easy to forge.

Patent application EP 0 211 754 describes a method for marking on a security document which consists in carrying out a reaction for the synthesis of a fluorescent chelate which is visible solely under specific lighting and not by daylight. The fluorescent marking obtained can be erased by application of an acidic or basic solution.

Patent application FR 2 315 132 describes a method for protecting against the falsification of documents having a coating of carbon applied under hot conditions, which consists in reacting a reactive component present on the document with an identifying reactant in order to bring about the appearance of a colored mark. The reactive component can be nickel chloride, incorporated in a carbon ink applied under hot conditions. The authenticating reactant can be diacetyl dioxime, which can be dropped in the form of drops onto the ink In the context of this patent, as the carbon ink is black or purple, the reactive component can be highly colored or weakly colored but can be incorporated in a high proportion in the ink, without, however, modifying the visual appearance of said document.

### SUMMARY

There exists a need to further strengthen the security of and the methods for authenticating security articles in order in particular to increase the difficulty in forging these articles.

There exists in particular a need to have an authenticating system which is easy to employ once the reactants are available.

A subject matter of the invention is thus, according to one of its aspects, a combination comprising an article to be authenticated, an authenticating composition and a device for application of the composition capable of holding, in particular by capillary action, said composition, the article to be authenticated comprising a first reactant, chosen from nickel, copper, cobalt or iron derivatives or from oxime derivatives or dithiooxamide, capable of reacting with a second reactant of the authenticating composition, respectively chosen from oxime derivatives or dithiooxamide or from nickel, copper, cobalt or iron derivatives, in order to form a visible and permanent colored mark.

In other words, either the first reactant is chosen from nickel, copper, cobalt or iron derivatives and the second reactant is chosen from oxime derivatives or dithiooxamide, or the first reactant is chosen from oxime derivatives or dithiooxamide and the second reactant is chosen from nickel, copper, cobalt or iron derivatives.

In particular, the article to be authenticated comprising the first reactant is not detrimentally affected, either in its properties, in particular of mechanical strength, or in its appearance, in particular its optical and visual characteristics, by the presence of said first reactant.

“Visible” is understood to mean that the mark can be perceived by the naked eye directly and/or using any appropriate optical system.

“Permanent” is understood to mean that the mark does not spontaneously disappear after drying, in particular after a few seconds.

Preferably, the first reactant is chosen from nickel, copper, cobalt or iron derivatives and the second reactant is chosen from oxime derivatives or dithiooxamide. In that way, the article to be authenticated comprises the most stable and least expensive reactant.

The authenticating composition may or may not be present in the application device.

The authenticating composition can be liquid, in particular in the form of an ink.

The application device can be in the form of a pen, of a brush, of a pad or of a felt tip.

The authenticating composition can also be present in containers of all types. In particular, said container may or may not be incorporated in the application device.

In particular, the authenticating composition can be held in the application device by capillary action. This may be in particular a pen or a felt tip.

According to another specific case, the authenticating composition can be held in the application device by a phenomenon of surface adhesion (surface tension). This may be in particular a pad.

The use of an application device according to the invention can make it possible to apply a minimum amount of composition to the article during the authentication.

The article to be authenticated can be a security document, for example a security sheet.

The article can be a means of payment, such as a bank note, a check or a restaurant ticket, an identity document, such as an identity card or a visa or a passport or a driving licence, a lottery ticket, a travel document or an entrance ticket for cultural or sports events, inter alia.

The article to be authenticated can also be chosen from a security label, a packaging, in particular a packaging for a medicament or for foods or for cosmetics or fragrances or for electronic components or for spare parts, a sheet used in the medical or hospital field, in particular a paper used to prepare sterilization packagings, or an art paper.

The first reactant can be present in the body of said article to be authenticated or also at the surface of said article to be authenticated.

The article can comprise a surface coat. “Coat” is understood to mean a composition comprising at least one pigment (or inorganic filler) and at least one binder, and which is intended to be applied to a support. This term is commonly used in this sense, in particular in the papermaking field.

Advantageously, the article can be a paper comprising a surfacing coat, in particular a surfacing coat applied using a size press. The reaction between said first reactant and said second reactant is thus rendered easier and is thus faster.

“Paper” is understood to mean any fibrous cellulose support but also more generally any fibrous support. Said paper can comprise papermaking fibers known to a person skilled in the art, for example cellulose fibers (in particular cotton fibers) and/or natural organic fibers other than cellulose fibers and/or synthetic fibers, for example polyester or polyamide fibers, and/or optionally inorganic fibers, such as glass fibers.

According to a specific case of the invention with an article made of paper, the salts derived from nickel, cobalt, copper or iron and which are soluble in water should be incorporated in a surfacing coat. This is because, due to their solubility, such salts are not retained within the fibrous mat during the dewatering of said article made of paper during manufacture.

In that way, the article may not require a subsequent additional treatment in order to make possible the incorporation of the first reactant.

Furthermore, the first reactant can thus be incorporated over a large part of the surface of the article, indeed even over the whole of the surface of the article.

The article, in particular the surfacing coat, can comprise a binder, for example starch or polyvinyl alcohol (PVA).

The article, in particular the surfacing coat, can comprise a surface sizing agent, in particular a polyacrylate, a polyurethane or their derivatives.

The article, in particular the surfacing coat of the article, can comprise fillers, in particular fillers commonly used in the papermaking field, for example of the kaolin, talc or calcium carbonate type.

The nickel, cobalt, copper or iron derivatives can be derivatives with a +II oxidation state. Use is preferably made of nickel derivatives.

The nickel derivatives can be nickel salts. Preferably, these nickel salts will be chosen from the least colored and the least toxic nickel salts. The nickel salts can thus, for example, be chosen from nickel sulfates, nickel acetates, nickel nitrates and nickel chlorides.

The first reactant or the second reactant can also be devoid of nickel chloride.

The total concentration of the first reactant in the article to be authenticated can be between 0.01 and 5 g/m² and preferably between 0.1 and 0.5 g/m².

The first reactant of the article to be authenticated can also be incorporated in a coat applied to the article to be authenticated, for example a pigmented coat based on polymers and fillers.

The reactant can, for example, be incorporated in a pigmented coat of a document of the Polyart® type sold by the applicant company. Such a document comprises a synthetic film which comprises in particular layers of coextruded polymers and which can have a pigmented surface coat which makes possible the printability thereof. Such documents are, for example, described in application EP 0 470 760.

The reactant present in the article to be authenticated can, for example, be introduced into a surface coat which makes possible the printability.

The oxime derivatives can be chosen from diacetyl dioxime or oxime salts, in particular sodium dimethylglyoximate. The choice will preferably be made of sodium dimethylglyoximate, for its ability to dissolve in the authenticating composition.

The first reactant or the second reactant can also be deprived of diacetyl dioxime.

The total concentration of second reactant in the authenticating composition can be between 0.1 and 200 g/l and preferably between 1 and 50 g/l.

The authenticating composition can preferably comprise an aqueous phase. The authenticating composition can also comprise an alcoholic or glycolic solvent in order to facilitate the dissolution of the oxime derivatives. Mixtures of aqueous and/or alcoholic and/or glycolic solvents are also possible.

The authenticating composition can also comprise at least one sequestering agent, for example ethylenediaminetetraacetic acid (EDTA) and/or trisodium orthophosphate.

The presence of a sequestering agent can make it possible to complex elements which, in their initial form, that is to say noncomplexed form, may result in a premature colored reaction.

Preferably, said sequestering agent is added to an authenticating composition comprising water, particularly in order to dissolve said sequestering agent.

The presence of a sequestering agent in the authenticating composition can make it possible to complex the inorganic materials present in the aqueous phase, such as iron or copper, which might result in a premature colored reaction with the oxime derivatives.

A person skilled in the art can use additional compounds in order to adjust the pH of the authenticating composition. In that way, it is possible to maintain reactants in a form which favors the reaction as a function of the pH range. For this, the authenticating composition can comprise a pH buffer chosen as a function of the reactants used. The pH buffer can, for example, be prepared from trisodium orthophosphate.

Advantageously, the authenticating composition can comprise a trisodium phosphate salt, for example trisodium orthophosphate, having both a role of sequestering agent and a role of pH buffer.

The authenticating composition can exhibit a pH of between 4 and 14, preferably between 10 and 14.

Preferably, the first and second reactants are chosen so as to obtain a rapid reaction, which can correspond to the appearance of a colored mark in less than 60 seconds, preferably less than 5 seconds, after bringing the first and second reactants into contact.

In the same way, the authenticating composition and the method of incorporation of the first reactant in the article to be authenticated (in the body, at the surface, and the like) are chosen so as to obtain a rapid reaction, which can correspond to the appearance of a colored mark in less than 60 seconds, preferably less than 5 seconds, after bringing the article to be authenticated comprising said first reactant into contact with the authenticating composition.

A further subject matter of the invention, according to another of its aspects, is a packaging and application device for applying an authenticating composition for the authentication of an article, this article comprising a first reactant chosen from nickel, copper, cobalt or iron derivatives or from oxime derivatives or dithiooxamide, this first reactant being capable of bringing about the formation of a visible and permanent colored mark on contact with a second reactant which is present in the authenticating composition and which is chosen respectively from oxime derivatives or dithiooxamide or from nickel, copper, cobalt or iron derivatives, the device comprising an application device capable of holding said composition by capillary action.

A further subject matter of the invention, according to another of its aspects, is a method for authenticating an article comprising a first reactant chosen from nickel, copper, cobalt or iron derivatives or from oxime derivatives or dithiooxamide, which consists in bringing the article into contact with an application device charged with an authenticating composition comprising a second reactant chosen respectively from oxime derivatives or dithiooxamide or from nickel, copper, cobalt or iron derivatives, the application device being capable of holding the authenticating composition by capillary action.

A further subject matter of the invention, according to another of its aspects, is a process for the manufacture of an article to be authenticated made of paper in which a reactant chosen from nickel, copper, cobalt or iron derivatives or from oxime derivatives or dithiooxamide is incorporated in a surfacing coat applied to the article using a size press. Said reactant is preferably a soluble nickel salt.

### Example 1

Use is made of an article to be authenticated in the form of a paper document comprising 50% of long fibers and 50% of short fibers. The document additionally comprises 6% by weight of filler of the kaolin type and a bulk sizing agent based on AKD at a level of 3% and comprising in a size press 5% of polyvinyl (PVA) and 0.5% of nickel sulfate (NiSO₄).

Use is also made of an authenticating composition comprising 1 liter of water and 40 grams of sodium dimethylglyoximate.

When the authenticating composition is used in the form of an ink present in an application device in the form of a pen or of a felt tip and when the latter is brought into contact with the article to be authenticated, a permanent red-colored mark visible in daylight is produced on the article to be authenticated. This red-colored mark results from the formation of a bis(dimethylglyoximato)nickel precipitate.

Said red-colored mark appears rapidly, that is to say in less than 5 seconds after said contacting operation.

In addition, when the authenticating composition is brought into contact with a document made of paper other than according to the invention, for example comprising chemical reactants sensitive to the normal falsification products (acids, bases, bleach, solvents), such as, for example, the Chemiguard® paper sold by the applicant company, a colored mark related to the page of the authenticating composition is produced but this colored mark exhibits a different color from that obtained with the article to be authenticated comprising the nickel salt.

### Example 2

Use is made of an article to be authenticated in the form of a paper document comprising 50% of long fibers and 50% of short fibers. The document additionally comprises 6% by weight of filler of the kaolin type and a bulk sizing agent based on AKD at a level of 3% and comprising in a size press 5% of polyvinyl (PVA) and 0.5% of nickel sulfate (NiSO₄).

Use is also made of an authenticating composition comprising 1 liter of water and 1 gram of dithiooxamide or rubeanic acid.

When the authenticating composition is used in the form of an ink present in an application device in the form of a pen or of a felt tip and when the latter is brought into contact with the article to be authenticated, a permanent mark colored yellow which changes to purple and which is visible in daylight is produced on the article to be authenticated. This colored mark results from the polymerization between the rubeanic acid and the nickel ions.

In this example, said mark colored yellow changes to purple in less than 45 seconds after said contacting operation. In addition, when the authenticating composition is brought into contact with a document made of paper other than according to the invention, for example comprising chemical reactants sensitive to the normal falsification products (acids, bases, bleach, solvents), such as, for example, the Chemiguard® paper sold by the applicant company, a colored mark related to the pH of the authenticating composition is produced but this colored mark exhibits a different color from that obtained with the article to be authenticated comprising the nickel salt.

### Example 3

Use is made of the article to be authenticated of example 1 and of an authenticating composition comprising 1 liter of water, 80 grams of trisodium orthophosphate and 40 grams of sodium dimethylglyoximate.

In this example, the trisodium orthophosphate acts both as pH buffer and as sequestering agent with regard to the iron and copper ions present in the water, which are capable of also reacting with the sodium dimethylglyoximate. This authenticating composition thus exhibits a greater stability than that of example 1.

### Example 4

Use is made of the authenticating composition of example 1 and of an article to be authenticated in the form of a document of Polyart® type sold by the applicant company. Such a document comprises a synthetic film which comprises in particular coextruded layers of polymers which can have a pigmented surface coat which makes possible the printability thereof. Such documents are, for example, described in the application EP 0 470 760.

The reactant present in the document to be authenticated can, for example, be a nickel derivative introduced into the surface coat which makes possible the printability . The expression “comprising a” (or “which comprises a”) is synonymous with “comprising at least one” (or “which comprises at least one”).

1-21. (canceled)

22. Combination comprising an article to be authenticated, an authenticating composition and a device for application of the composition capable of holding said composition by capillary action, wherein the article to be authenticated comprises a first reactant chosen from nickel, copper, cobalt or iron derivatives or from oxime derivatives or dithiooxamide,
wherein the first reactant is capable of reacting with a second reactant of the authenticating composition respectively chosen from oxime derivatives or dithiooxamide or from nickel, copper, cobalt or iron derivatives, and
wherein the first reactant is capable of reacting with the second reactant to form a visible and permanent colored mark.

23. Combination according to claim 22, wherein the application device is chosen from a pen, a brush, a pad or a felt tip.

24. Combination according to claim 22, wherein the article to be authenticated comprises a security document chosen from a means of payment, an identity document, a lottery ticket, a travel document, an entrance ticket for cultural or sports events, a security label, a packaging, a sheet used in the medical or hospital field, or an art paper.

25. Combination according to claim 22, wherein the nickel derivatives are nickel salts.

26. Combination according to claim 25, wherein the nickel salts are chosen from nickel sulfates, nickel acetates, nickel nitrates or nickel chlorides.

27. Combination according to claim 22, wherein the article to be authenticated comprises a paper comprising a surfacing coat.

28. Combination according to claim 27, wherein the article comprises a surfacing coat applied using a size press.

29. Combination according to claim 22, wherein the oxime derivatives are chosen from diacetyl dioxime or salts of dimethylglyoxime.

30. Combination according to claim 29, wherein the oxine derivatives comprise sodium dimethylglyoximate.

31. Combination according to claim 22, wherein the authenticating composition exhibits a pH ranging from 4 to 14.

32. Combination according to claim 31, wherein the pH ranges from 10 and 14.

33. Combination according to claim 22, wherein the authenticating composition comprises at least one sequestering agent.

34. Combination according to claim 33, wherein the authenticating composition comprises water.

35. Combination according to claim 22, wherein the authenticating composition comprises ethylenediaminetetraacetic acid (EDTA) and/or trisodium orthophosphate.

36. Combination according to claim 22, wherein the authenticating composition comprises a pH buffer.

37. Combination according to claim 36, wherein the authenticating composition comprises trisodium orthophosphate.

38. Combination according to claim 33, wherein the authenticating composition comprises a trisodium phosphate salt having both a role of sequestering agent and a role of pH buffer.

39. Combination according to claim 38, wherein the salt is trisodium orthophosphate.

40. A packaging and application device for applying an authenticating composition for the authentication of an article, the article comprising a first reactant chosen from nickel, copper, cobalt or iron derivatives or from oxime derivatives or dithiooxamide, wherein the first reactant is capable of bringing about the formation of a visible and permanent colored mark on contact with a second reactant which is present in the authenticating composition, and wherein the second reactant is chosen respectively from oxime derivatives or dithiooxamide or from nickel, copper, cobalt or iron derivatives, wherein the device comprises an application device capable of holding the composition by capillary action.

41. A method for authenticating an article comprising a first reactant chosen from nickel, copper, cobalt or iron derivatives or from oxime derivatives or dithiooxamide, which consists in bringing the article into contact with an application device charged with an authenticating composition comprising a second reactant chosen respectively from oxime derivatives or dithiooxamide or from nickel, copper, cobalt or iron derivatives, the application device being capable of holding the authenticating composition by capillary action.

42. Process for the manufacture of an article to be authenticated made of paper in which a reactant chosen from nickel, copper, cobalt or iron derivatives or from oxime derivatives or dithiooxamide is incorporated in a surfacing coat applied using a size press.
